(19) United States
(12) Patent Application Publication
(10) Pub. No.: US 2014/0351042 A1
(43) Pub. Date: Nov. 27, 2014

(54) SYSTEMS AND METHODS FOR MANAGING AND TRACKING RECOMMENDATION/PURCHASE RELATIONSHIPS

(71) Applicant: Elah Valley International, Inc., Atlanta, GA (US)

(72) Inventors: Jayant CHAUDHARY, Suwanee, GA (US); Thomas E. GALIDO, Westchester, CA (US)

(73) Assignee: Elah Valley International, Inc., Atlanta, GA (US)

(21) Appl. No.: 14/272,276

(22) Filed: May 7, 2014

Related U.S. Application Data
(60) Provisional application No. 61/820,403, filed on May 7, 2013.

(51) Int. Cl. G06Q 30/02

(52) U.S. Cl. CPC G06Q 30/0246
USPC 705/14.45

(57) ABSTRACT

A transaction tracing system that includes a seller, a buyer, and several recommenders using an internet enabled device that can track and store all data associated with the chain of recommendations that lead to a discrete transaction. The tracing system, through the internet enabled device of the buyer enables a full tracking of the recommending events leading to a fully consummated transaction.

### CROSS REFERENCE TO RELATED APPLICATION

This application claims benefit under 35 U.S.C. §119(e) of U.S. Provisional Patent Application No. 61/820,403, filed May 7, 2013, and entitled “System and Method for Tracking Recommendation/Purchase Relationships”, which is incorporated herein by reference as if set forth herein in its entirety.

### TECHNICAL FIELD

The present disclosure is in the technical field of electronic transactions. More particularly, the present disclosure is in the technical field of tracking online recommendations and resulting purchases via online networks and social media systems.

### BACKGROUND

The merger between online shopping and social media has caused online retailers to greatly increase their online advertising by allowing users to share their recommended purchases or items to others found in the various social networks of the users. These recommendations can lead to further purchases and recommendations of the product/item in the subsequent users' social networks, which can lead to additional purchases/recommendations amongst other users. However, there is currently not a way to trace a discrete purchase back through the chain of recommendations that preceded it.

Therefore, there is a need for a system or method to fully track the recommending events that lead to a fully consummated transaction. In addition, there is a need for a system to understand multiple levels of recommendations at a data tracking level organized in such a way to understand the recommendation/purchase relationships.

### BRIEF SUMMARY OF THE DISCLOSURE

Briefly described, and according to one embodiment, aspects of the present disclosure generally relate to systems and methods for tracking and identifying recommending events that lead to a fully consummate online transaction. In an aspect, the recommendation tracing system can be configured to track and store all data from a chain of recommendations that lead to a discrete transaction. In an aspect, the transactions and recommendations can be carried out through an internet enabled device. In an aspect, the tracking system can be utilized to reward individuals that share a recommendation that ultimately leads to a discrete transaction.

According to one aspect, there is provided a method for managing and tracking product/service recommendations, comprising receiving an indication at a central server from a user via a user device application relating to a recommendation of a product/service, wherein the recommendation corresponds to an online network. The method may further include generating a transaction opportunity identifier at the central server associated with the recommendation, wherein the transaction opportunity identifier includes an user identifier corresponding to the user device application and a recommendation identifier corresponding to the recommendation. The method may further include transmitting the transaction opportunity identifier from the central server to the user device application. The method may further include publishing the transaction opportunity identifier to the online network in connection with the recommendation of the user, whereby the published transaction identifier enables tracking of engagement by other online network users with the recommendation of the product/service by the user.

In certain embodiments, the method may further comprise receiving an indication at the central server from a further user indicating engagement with the transaction opportunity identifier in connection with the recommendation of the product/service by the user; creating a log entry within the central server of the indication from the further user indicating engagement with the recommendation of the product/service by the user; and storing the log entry reflecting the further user's engagement with the recommendation of the product/service by the user.

In certain embodiments, the log entry comprises the transaction opportunity identifier, the recommendation identifier, the user identifier, a session identifier, a time identifier, a date identifier, and/or a location identifier. In one aspect, the further user's engagement comprises a purchase of the product/service in connection with the recommendation of the product/service.

In certain embodiments, the method further comprises receiving payment information corresponding to a payment process in connection with the further user's engagement of the transaction opportunity identifier. In one aspect, the method further comprises creating a transaction data element in connection with completion of the payment process of the further user, wherein the transaction data element includes transaction information corresponding to the further user's engagement with the transaction opportunity identifier; and correlating at the central server the transaction data element to the recommendation identifier corresponding to the product/service of the recommendation.

In certain embodiments, the transaction information includes a product/service identifier and a session identifier. Further, in certain aspects, a correlation engine correlates the transaction data element to the recommendation of the product/server of the user via the session identifier. In some aspects, the further user's engagement comprises a re-recommendation of the product/service in connection with the user's recommendation of the product/service as it corresponds to the online network. In an aspect, receiving the indication from the user comprises an electronic request from a user electronic device.

In certain embodiments, the method further comprises receiving an indication at the central server from a further user via a user device application relating to a recommendation of the product/service after completion of the further user's engagement with the transaction opportunity identifier, wherein the recommendation corresponds to the online network.

In one embodiment, there is provided a system for managing and tracking product/service recommendations comprising at least one server operatively connected to a plurality of devices associated with one or more users desirous of making recommendations of one or more products/services, at least one database for storing information relating to the one or more recommendations of products/services made by one or more users, and the one or more transactions made by at the one or more users. In certain embodiments, the system comprises a processor operatively coupled between the at least one server and the at least one database, wherein the processor is operatively configured to receive an indication at the at least one server from a user via a user device application relating to a recommendation of a product/service, wherein the recommendation corresponds to an online network, generate a transaction opportunity identifier at the at least one server associated with the recommendation, wherein the transaction opportunity identifier includes an user identifier corresponding to the user device application and a recommendation identifier corresponding to the recommendation. In certain embodiments, the system is further operatively configured to transmit the transaction opportunity identifier from at least one server to the user device application; and publish the transaction opportunity identifier to the online network in connection with the recommendation of the user, whereby the published transaction identifier enables tracking of engagement by other online network users with the recommendation of the product/service by the user.

In certain embodiments, the processor is further operatively configured to receive an indication at the at least one server from a further user indicating engagement with the transaction opportunity identifier in connection with the recommendation of the product/service by the user, create a log entry within the at least one server of the indication from the further user indicating engagement with the recommendation of the product/service by the user, and store the log entry in the at least one database reflecting the further user's engagement with the recommendation of the product/service by the user. In certain aspects, the log entry comprises the transaction opportunity identifier, the recommendation identifier, the user identifier, a session identifier, a time identifier, a date identifier, and/or a location identifier.

In certain aspects, the further user's engagement comprises a purchase of the product/service in connection with the recommendation of the product/service. The correlation engine correlates the transaction data element to the recommendation of the product/server of the user via the session identifier. In some aspects, the transaction information includes a product/service identifier and a session identifier.

In some embodiments, the processor is further operatively coupled to receive payment information corresponding to a payment process in connection with the further user's engagement of the transaction opportunity identifier, create a transaction data element in connection with completion of the payment process of the further user, wherein the transaction data element includes transaction information corresponding to the further user's engagement with the transaction opportunity identifier, and correlate at the at least one server the transaction data element to the recommendation identifier corresponding to the product/service of the recommendation.

In certain embodiments, the processor is further operatively configured to receive an indication from a further user via a user device application relating to a recommendation of the product/service after completion of the further user's engagement with the transaction opportunity identifier, wherein the recommendation corresponds to the online network. In an aspect, a correlation engine correlates the transaction data element to the recommendation of the product/server of the user via the session identifier. In certain aspects, the further user's engagement comprises a re-recommendation of the product/service in connection with the user's recommendation of the product/service as it corresponds to the online network. In one aspect, receipt of the indication from the user comprises an electronic request from a user electronic device.

In certain embodiments, there is provided a method for managing and tracking product/service recommendations, comprising receiving an indication at a central server from a first user via a first user device application relating to a recommendation of a product/service, wherein the recommendation corresponds to an online network and generating a transaction opportunity identifier at the central server associated with the recommendation, wherein the transaction opportunity identifier includes an first user identifier corresponding to the first user device application and a recommendation identifier corresponding to the recommendation. The method further comprising transmitting the transaction opportunity identifier from the central server to the first user device application, publishing the transaction opportunity identifier to the online network in connection with the recommendation of the first user, and receiving an indication at the central server from a second user device application relating to a further recommendation of the product/service from the first user, wherein the further recommendation includes the published transaction opportunity identifier corresponding to the recommendation of the first user. In certain embodiments, the method further comprises generating a second transaction opportunity identifier at the central server associated with the further recommendation, wherein the second transaction opportunity identifier includes the transaction opportunity identifier, a further recommendation identifier, a second user identifier corresponding to the second user device application, and the recommendation identifier, transmitting the second transaction opportunity identifier from the central server to the second user device application, and publishing the second transaction opportunity identifier to the online network in connection with the further recommendation of the second user. Further, the second published transaction identifier enables tracking of engagement by other online network users with the recommendation of the product/service by the first user.

In certain embodiments, the method further comprising receiving an indication at the central server from a further user indicating engagement with the second transaction opportunity identifier in connection with the recommendation of the product/service by the first user, creating a log entry within the central server of the indication from the further user indicating engagement with second transaction opportunity identifier in connection with the recommendation of the product/service by the first user, and storing the log entry reflecting the further user's engagement with the second transaction opportunity in connection with the recommendation of the product/service by the first user.

In certain embodiments, the log entry comprises the second transaction opportunity identifier, the further recommendation identifier, the user identifier, a session identifier, a time identifier, a date identifier, and/or a location identifier. In one aspect, the further user's engagement comprises a purchase of the product/service in connection with the recommendation of the product/service by the first user.

In certain embodiments, the method further comprising receiving payment information corresponding to a payment process in connection with the further user's engagement of the second transaction opportunity identifier, creating a transaction data element in connection with completion of the payment process of the further user, wherein the transaction data element includes transaction information corresponding to the further user's engagement with the second transaction opportunity identifier, and correlating at the central server the transaction data element to the recommendation identifier corresponding to the product/service of the recommendation by the first user. In certain aspects, the transaction information includes a product/service identifier and a session identifier.

In certain embodiments, there is provided a system for managing and tracking product/service recommendations comprising at least one server operatively connected to a plurality of devices associated with one or more users desirous of making recommendations of one or more products/services, and at least one database for storing information relating to the one or more recommendations of products/services made by the one or more users, and the one or more transactions made by the one or more users. In certain embodiments, the system further comprises a processor operatively coupled between the at least one server and the at least one database, wherein the processor is operatively configured to receive an indication at the at least one server from a first user via a user device application relating to a recommendation of a product/service, wherein the recommendation corresponds to an online network. In certain embodiments, the processor is further operatively configured to generate a transaction opportunity identifier at the at least one server associated with the recommendation, wherein the transaction opportunity identifier includes an first user identifier corresponding to the first user device application and a recommendation identifier corresponding to the recommendation, transmit the transaction opportunity identifier from the at least one server to the first user device application, publish the transaction opportunity identifier to the online network in connection with the recommendation of the first user, and receive an indication at the at least one server from a second user device application relating to a further recommendation of the product/service from the first user, wherein the further indication includes the published transaction opportunity identifier corresponding to the recommendation of the first user. In certain embodiments, the processor is further operatively configured to generate a second transaction opportunity identifier at the at least one server associated with the further recommendation, wherein the second transaction opportunity identifier includes the transaction opportunity identifier, a further recommendation identifier, a second user identifier corresponding to the second user device application, and the recommendation identifier, and transmit the second transaction opportunity identifier from the central server to the first user device application. In certain embodiments, the processor is further operatively configured to publish the second transaction opportunity identifier to the online network in connection with the further recommendation of the second user, whereby the second published transaction identifier enables tracking of engagement by other online network users with the recommendation of the product/service by the first user.

In certain aspects, the processor is further operatively coupled to receive an indication at the at least one server from a further user indicating engagement with the second transaction opportunity identifier in connection with the recommendation of the product/service by the first user. In certain aspects, the processor is further operatively coupled to create a log entry within the at least one server of the indication from the further user indicating engagement with second transaction opportunity identifier in connection with the recommendation of the product/service by the first user, and store the log entry in the at least one database reflecting the further user's engagement with the second transaction opportunity in connection recommendation of the product/service by the first user.

In certain aspects, the log entry comprises the second transaction opportunity identifier, the further recommendation identifier, the user identifier, a session identifier, a time identifier, a date identifier, and/or a location identifier. In other aspects, the further user's engagement comprises a purchase of the product/service in connection with the recommendation of the product/service by the first user.

In certain embodiments, the processor is further operatively coupled to receive payment information corresponding to a payment process in connection with the further user's engagement of the second transaction opportunity identifier, create a transaction data element in connection with completion of the payment process of the further user, wherein the transaction data element includes transaction information corresponding to the further user's engagement with the second transaction opportunity identifier, and correlate at the at least one server the transaction data element to the recommendation identifier corresponding to the product/service of the recommendation by the first user. In some aspects, the transaction information includes a product/service identifier and a session identifier.

These and other objects and advantages of the disclosure will become apparent from the following detailed description of the preferred embodiment of the disclosure. Both the foregoing general description and the following detailed description are exemplary and explanatory only and are intended to provide further explanation of the disclosure as claimed. The accompanying drawings are included to provide a further understanding of the disclosure and are incorporated in and constitute part of this specification, illustrate several embodiments of the disclosure, and together with the description serve to explain the principles of the disclosure.

These and other aspects, features, and benefits of the claimed disclosure(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a schematic representation of a recommendation tracking system according to an aspect of the present disclosure.

FIG. 2 is a schematic view of an internet enabled device of the system of FIG. 1 according to an aspect of the present disclosure.

FIG. 3 is a representative schematic view of the servers of FIG. 1 according to an aspect of the present disclosure.

FIG. 4 illustrates an image of a mobile electronic device illustrating a screen capture representing the opportunity to make a recommendation according to an aspect of the present disclosure.

FIG. 5 is a block diagram of data elements associated with a recommendation ID according to an aspect of the present disclosure.

FIG. 6 is a block diagram of data elements associated with a transaction opportunity according to an aspect of the present disclosure.

FIG. 7 is a screen capture of an image of the presentation of a transaction opportunity according to an aspect of the present disclosure.

FIG. 8 is a screen capture of an image of the presentation of a transaction opportunity according to an aspect of the present disclosure.

FIG. 9 is a screen capture of an image of the presentation of a transaction opportunity according to an aspect of the present disclosure.

FIG. 10 is a screen capture of an image of the presentation of a transaction opportunity according to an aspect of the present disclosure.

FIG. 11 is an image of initiating a potential purchase from a transaction opportunity according to an aspect of the present disclosure.

FIG. 12 is a block diagram of data elements associated with a session according to an aspect of the present disclosure.

FIG. 13 is a block diagram of data elements associated with a log entry according to an aspect of the present disclosure.

FIG. 14 is a block diagram of data elements associated with a transaction according to an aspect of the present disclosure.

FIG. 15 is a schematic representation of linking a recommendation ID to a transaction according to an aspect of the present disclosure.

FIG. 16 is a schematic representation of recommendation IDs connected to transactions according to an aspect of the present disclosure.

FIGS. 17-18 illustrate incentive results utilizing the system of FIG. 1 according to an aspect of the present disclosure.

FIG. 19 is a table illustrating revenue tracking for a given product or service utilizing the system of FIG. 1 according to one aspect of the present disclosure.

FIG. 20A is a flow chart illustrating a first portion of an exemplary managing and tracking recommendation/purchase relationships process according to one embodiment of the present disclosure.

FIG. 20B is a flow chart illustrating a second portion of an exemplary managing and tracking recommendation/purchase relationships process according to one embodiment of the present disclosure.

FIG. 21 is an exemplary screen shot of a purchase report according to one embodiment of the present disclosure.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

All publications, patents, and published patent applications referred to in this application are specifically incorporated by reference herein. In case of conflict, the present specification, including its specific definitions, will control.

Throughout this specification, the term “comprise” or variations such as “comprising” or “comprises” will be understood to imply the inclusion of a stated integer (or component) or group of integers (or components), but not the exclusion of any integer (or component) or group of integers (or components). The singular forms “a”, “an”, and “the” include the plurals unless the context clearly dictates otherwise.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for tracking and identifying all recommending events that lead to a fully consummate online transaction. In an aspect, the recommendation tracing system can be configured to track and store all data from a chain of recommendations that lead to a discrete transaction. In an aspect, the transactions and recommendations can be carried out through an internet enabled device. In an aspect, the tracking system can be utilized to reward individuals that share a recommendation that ultimately leads to a discrete transaction. Ion certain aspects, the present system is utilized in the field of social networks and social media systems.

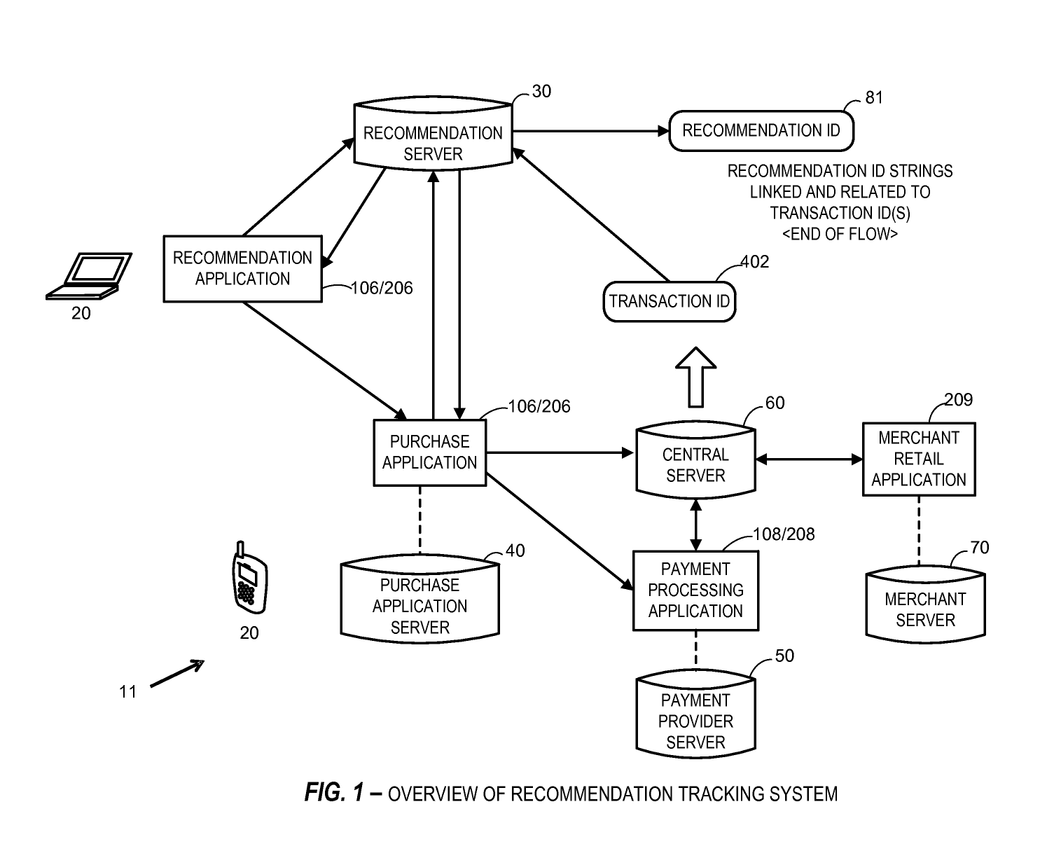

FIG. 1 illustrates a recommendation tracking system 11 according to an aspect of the present disclosure. As shown in FIG. 1, the recommendation tracking system 11 includes a plurality of internet enabled devices 20 that are configured to make recommendations and transactions based upon the actions taken by users associated with each internet enabled device 20. According to aspects of the present disclosure, the term “recommendation” generally refers to the act of or information about the act of indicating an affinity for a product or service (or information about a product or service) online via a social media or other online affinity mechanism. Non-limiting examples of recommendations include “likes” or “shares” (Facebook™), “tweets” (Twitter™), “posts” to Google+™ or Instagram™, “pins” on Pinterest™, or any other recommendation/affinity mechanism as will be understood by one of skill in the art. In other aspects, a recommendation could also be a traditional email that is forwarded amongst various users.

The internet enabled devices 20 can utilize a recommendation application 106, a purchase application 107, and a payment processing application 108 to facilitate such actions. In one embodiment, the recommendation application 106 of the internet enabled devices 20 communicates with a recommendation application 206 associated with a recommendation server 30. The purchase application 107 of the internet enabled devices 20 communicates with a purchase application 207 associated with a purchase application server 40. The payment processing application 108 of the internet enabled devices 20 communicates with a payment processing application 208 of a payment provider server 50. The purchase application 207 of the purchase application server 40 and the payment processing application 208 of the payment provider server 50 can communicate with a merchant retail application 209 associated with a merchant server 60. A central server 60 can help facilitate the communication between the various servers and internet enabled devices 20. As shown in FIG. 1, the recommendation tracking system 11 utilizes a recommendation ID 81 to track recommendations that lead to discrete transactions of the products and services. The discrete transactions can be identified using a transaction ID 402, which can ultimately be linked with recommendation IDs 81, as discussed in more detail below. As will be generally, understood by one of ordinary skill in the art the architecture discussed in conjunction with FIG. 1 is for exemplary purposes only and is not intended to limit the spirit or scope of the present disclosure as other architecture configurations may be used with the system of the present disclosure.

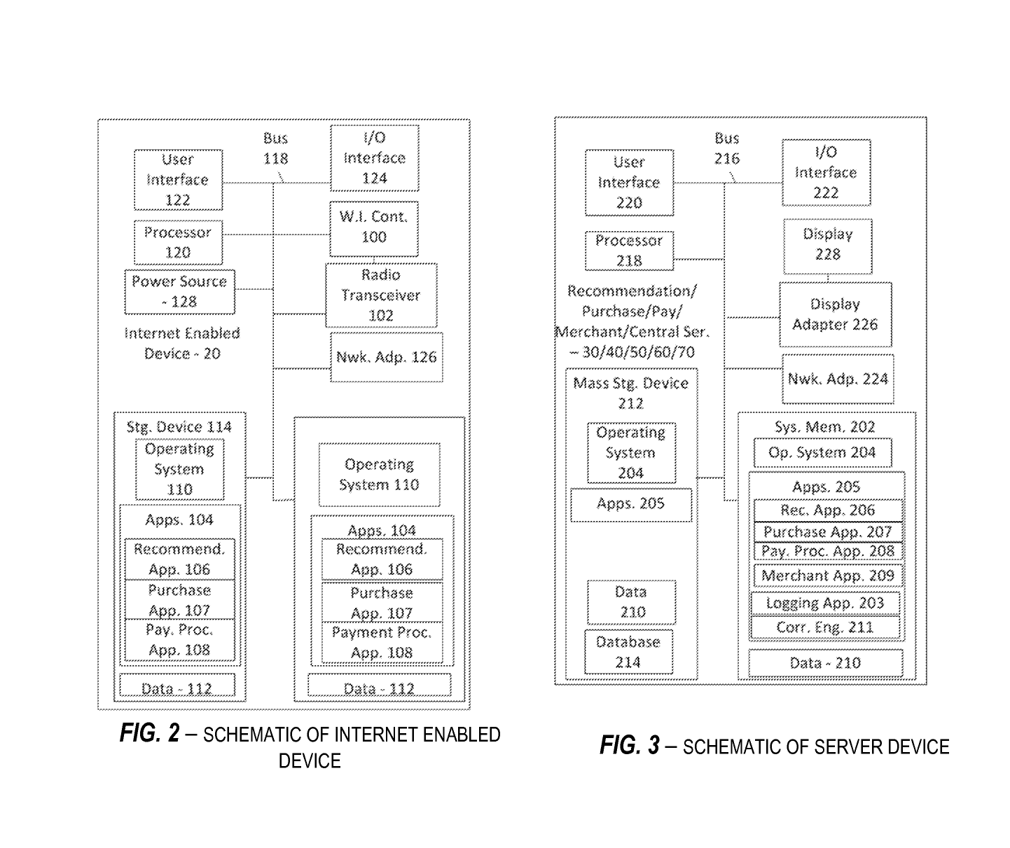

In one embodiment, the internet enabled device 20 is configured for use by a user to access information and carry out events, including recommendations and transactions, over the Internet. In an aspect, the internet enabled device 20 can include, but is not limited to, laptop computers, tablets, smart phones, PDA's, hand held computers, and the like. According to an aspect, as shown in FIG. 2, the internet enable devices 20 include a combination wireless interface controller 100 and radio transceiver 102. The wireless interface controller (“W.I. Cont.”) 100 is configured to control the operation of the radio transceiver 102, including the connections of the radio transceiver 102, as well as the receiving and sending of information from the recommendation server 30, purchase application server 40, payment provider server SO, central server 60, and/or merchant server 70.

The radio transceiver 102 may communicate on a wide range of public frequencies, including, but not limited to, frequency bands 2.4 GHz and/or SGHz-S.8 GHz. In addition, the radio transceiver 102, with the assistance of the wireless interface controller 100, may also utilize a variety of public protocols. For example, in some embodiments of the present disclosure, the combination wireless interface controller 100 and radio transceiver 102 may operate on various existing and proposed IEEE wireless protocols, including, but not limited to, IEEE 802.11b/g/n/a/ac, with maximum theoretical data transfer rates/throughput of 11 Mbps/S4 Mbps/600 Mbps/S4 MBpsI1 GBps respectively. In an aspect, the radio transceiver 102 can include a wireless cellular modem 102 configured to communicate on cellular networks. The cellular networks can include, but are not limited to, GPRS, GSM, UMTS, EDGE, HSP A, CDMA2000, EVDO Rev 0, EVDO Rev A, HSPA+, and WiMAX, LTE. In an aspect, the internet enabled device 20 may include a network adapter 126 (e.g., laptop computer) configured to communicate with other devices over various networks.

The internet enable devices 20 may have one or more software applications 104, including a recommendation application 106, a purchase application 107, and a payment process application 108. In an aspect, the recommendation application 106 allows a user to make a recommendation of an item or service. The purchase application 107 allows a user to purchase a recommended item or service. The payment process application 108 processes any payments associated with the item or service purchased.

In an aspect, the recommendation application 106 and purchasing application 107 can be in the same application, with the recommending and purchasing being two separate functions performed by the application. For example, the recommendation application 106 and the purchasing application 107 can be included or associated with a mobile application that is commonly offered to mobile devices (e.g. Facebook™, Amazon™, eBay™, and the like). In addition, the payment process application 108 can be associated with mobile applications as well. In an aspect, the internet enabled device 20 can include multiple applications that include individual recommendation and purchasing applications.

In one embodiment, the internet enabled device 20 includes system memory 109, which can store the various applications 104, including those mentioned above, as well as the operating system 110. The system memory 109 may also include data 112 accessible by the various software applications. The system memory 109 can include random access memory (RAM) or read only memory (ROM). Data 112 stored on the internet enabled device 20 may be any type of retrievable data. The data may be stored in a wide variety of databases, including relational databases, including, but not limited to, Microsoft Access and SQL Server, MySQL, INGRES, DB2, INFORMIX, Oracle, PostgreSQL, Sybase 11, Linux data storage means, and the like.

The internet enabled device 20 can include a variety of other computer readable media, including a storage device 114. The storage device 114 can be used for storing computer code, computer readable instructions, program modules, and other data 112 for the internet enabled device 20, and the storage device 14 can be used to back up or alternatively to run the operating system 110 and/or other applications 104, including the recommendation application 106, the purchase application 107, and the payment process application 108. The storage device 114 may include a hard disk, various magnetic storage devices such as magnetic cassettes or disks, solid-state flash drives, or other optical storage, random access memories, and the like.

The internet enabled device 20 may include a system bus 118 that connects various components of the internet enabled device 20 to the system memory 109 and to the storage device 114, as well as to each other. Other components of the internet enabled device 20 may include one or more processors or processing units 120, a user interface 122, and one or more input/output interfaces 124. In addition, the internet enabled device 20 includes a power source 128, including, but not limited to, a battery or an external power source.

As shown in FIG. 1, the recommendation tracing system 11 can include several servers. Such servers include, but are not limited to, a recommendation server 30, a purchase application server 40, a payment provider server 50, a central server 60, and a merchant server 70. FIG. 3 illustrates a representative server 30/40/50/60/70 that has components and applications that can be applicable to all of the servers. The servers may have several applications 205. The applications can include, but are not limited to, applications 205 that correspond to the applications 104 of the internet enabled device 20 (i.e., recommendation application 106/206, purchase application 107/207 and payment processing application 108/208). In addition, the merchant server 50 can include a logging application 203, a merchant application 209, and a correlation engine 211. In an aspect, the logging application 203 generates a log entry 300 for a request to make a recommendation and/or engage a transaction opportunity. In an aspect, correlation and related derivation of data is done by a correlation engine 211. In general, the servers and their respective applications 205 may utilize elements and/or modules of several nodes or servers. In any event, the servers 30/40/50/60/70 should be construed as inclusive of multiple modules, software applications, servers and other components that are separate from the internet enabled devices 20.

The servers 30/40/50/60/70 can include system memory 202, which stores the operating system 204 and various software applications 205. The servers may also include data 210 that is accessible by the software applications 205. The servers may include a mass storage device 212. The mass storage device 212 can be used for storing computer code, computer readable instructions, program modules, various databases 214, and other data for the central fleet management server 40. The mass storage device 212 can be used to back up or alternatively to run the operating system 204 and/or other software applications 205. The mass storage device 212 may include a hard disk, various magnetic storage devices such as magnetic cassettes or disks, solid state-flash drives, CD-ROM, DVDs or other optical storage, random access memories, and the like.

The servers 30/40/50/60/70 may include a system bus 216 that connects various components of the servers to the system memory 202 and to the mass storage device 212, as well as to each other. In an aspect, the mass storage device 212 can be found on the same server. In another aspect, the mass storage device can comprise multiple mass storage devices 212 that are found separate from the servers. However, in such aspects the separate storage servers can be provided access to each other and to the storage device 212.

Other components of the 30/40/50/60/70 servers may include one or more processors or processing units 218, a user interface 220, an input/output interface 222, and a network adapter 224 that is configured to communicate with other devices, including, but not limited to, servers associated with the recommendation tracking system, the internet enabled devices, other servers, and the like. The network adapter 224 can communicate over various networks. In addition, the servers may include a display adapter 226 that communicates with a display device 228, such as a computer monitor and other devices that present images and text in various formats. A system administrator can interact with the servers through one or more input devices (not shown), which include, but are not limited to, a keyboard, a mouse, a touch-screen, a microphone, a scanner, a joystick, and the like, via the user interface 218.

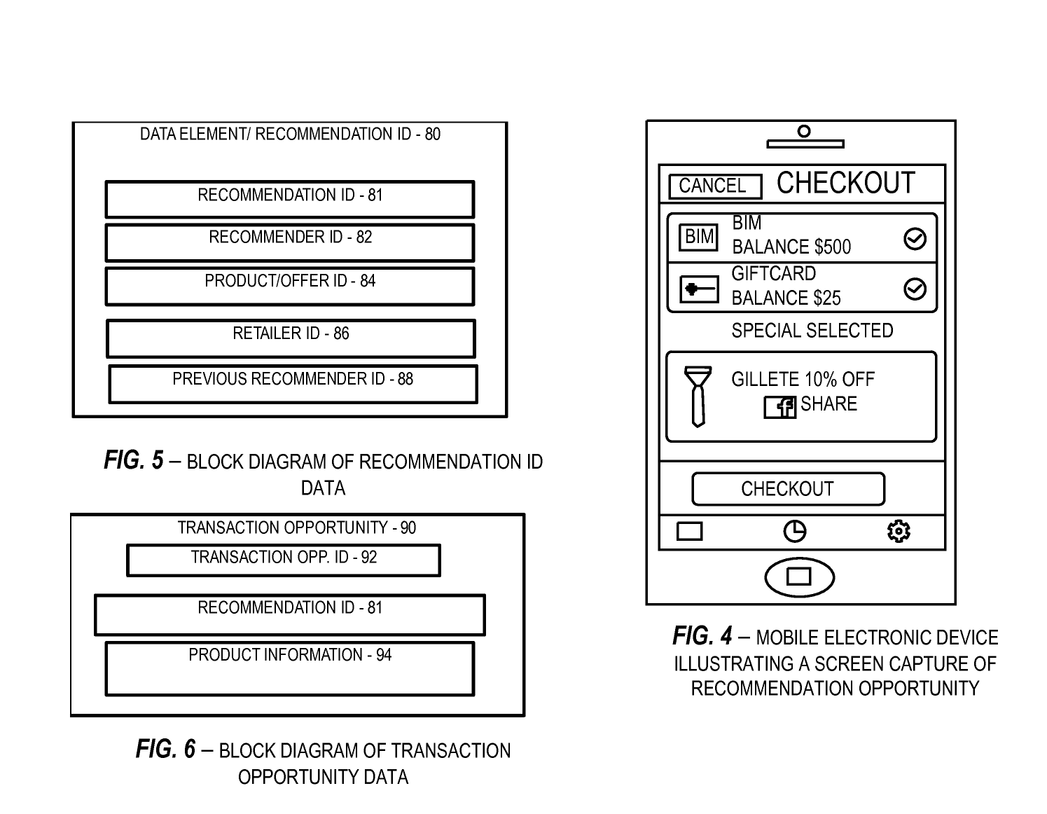

Generally, the recommendation tracking system 11 is utilized to track a recommendation. A user can be prompted to make a recommendation through the internet enabled device 20. For example, as shown in FIG. 4, a user can be provided with the opportunity to make a recommendation for a specific product. In such an example, the user can be prompted with a GUI stating, “would you like to share this product with your friends?” This prompting can come at the end of making a purchase of the product or after selecting a transaction opportunity 90, discussed in more detail below.

In one embodiment, a recommendation may be created by scanning a visual representation such as QR code, bar code, internet link, digital image, photograph, or the like, wherein the visual representation comprises campaign information about a product or service and would subsequently post to various predetermined social media networks. For example, a company may communicate (e.g., mail, email, social media post, etc.) various marketing campaigns and the marketing campaign comprises a visual representation required to create a recommendation. As will be generally understood, the first recommendation created may be referred to herein as a seed recommendation or “generation zero” and subsequent recommendations can be made from the “generation zero”.

In one embodiment, a recommendation may be created by liking, sharing, or posting about a product or service on a social media network via a retailer or third party website, wherein the present system recognizes the engagement between a product or service and a user's social media networks. For example, a user may browse a retailer website and see a product that he/she may engage with (e.g., like, share, post, etc.) the product on a social media site. The recommendation tracking system will see/recognize the engagement with the social network and offer to create a recommendation via the recommendation tracking system. Accordingly, the recommendation tracking system (e.g., mobile/web application) may engage the user's internet enabled device and inquire if the user would like to create a recommendation via the recommendation tracking system. In another aspect, the recommendation system may prompt the user to select which social media sites to publish the recommendation. If the user accepts to create a recommendation, the recommendation tracking system performs the processes outlined herewith. In another embodiment, the recommendation application 206 may comprise a browseable list of products to recommend for a “generation zero” recommendation. In another embodiment, the recommendation application 106 may engage a merchant retail application 209 and enable a user to make a recommendation from the merchant retail application 209 via the recommendation application 106.

In an aspect, when communication occurs between a client server (e.g., merchant server 70) and the recommendation server 30, a unique identifier is created that identifies every piece of a multi-level recommendation, including the original recommender, the product, the price, the time of the recommendation, actions resulting from that recommendation, and any additional recommenders and purchasers. However, all of this data is generally kept confidential and is not provided to end users; rather, the data is uniquely identified on the server-side and a unique identifier is assigned to it. Then that identifier is encrypted, so that it is not obviously linked to any of the aforementioned parameters (product, price, etc.). That identifier is then signed, and a data string with the encrypted identifier and its signature is sent back and forth between the server and any clients. In one aspect, the signature is a combination of information relating to and/or recommender, product, and promotion campaigns. According to one aspect, the signature may determine whether the purchase event is eligible for reward and which user would receive the reward. As will be generally understood, more information can be included in other containers in the data string that may become relevant in the future such as a merchant ID, etc.

As shown in FIG. 5 and in one embodiment, the recommendation entry 80 includes a recommendation ID 81, a recommender ID 82, a product/offer ID 84, a retailer ID 86, and a previous recommender ID 88. In one aspect, the recommendation entry 80 is a data element stored in the recommendation server that enables the system to manage and track various data about the recommendation throughout the recommendation/purchase process. The recommender ID 82 is a unique identifier of the recommender (the recommender is the user who requested to make a recommendation). In an aspect, the recommendation server 30 can call upon already established identifiers for the recommender ID 82. For example, the recommender ID 82 can include a hotel point program number, a unique username, or an email address. In such aspects, the recommender ID 82 is based upon whatever information that the application uses to uniquely identify individual users. In an aspect, due to regulation associated with payments, websites and mobile applications use a proprietarily generated anonymous unique number string to provide privacy for their users. The combination of the recommender ID 82, retailer ID 84 (if not concatenated in the product ID) and product ID 86 creates a unique value (product+recommender+retailer). This information is stored in the recommendation server 30 so it can be combined with the transaction ID later (if applicable). The recommendation application 206 of the recommendation server 30 will then save the recommendation entry 80, and the associated information, on the server 30 (e.g., in a database 214).

In another aspect, a previous recommender ID 88 can enable propagated recommendations to be tracked back to an original recommendation ID 81 and subsequently to an original recommender ID 82, such that the original recommender is credited with the creation of the recommendation chain. In other words, recommendations can be generational, wherein a single recommendation can continuously be reposted and/or shared by a series of recommenders who are different than the original recommender. As will be understood, a recommender, other than the original, may receive a recommendation or see a recommendation on social media. Upon viewing a recommendation, the recommendation can be reposted or recommended or a recommender can accept the recommendation and engage in a transaction for the advertised good or service.

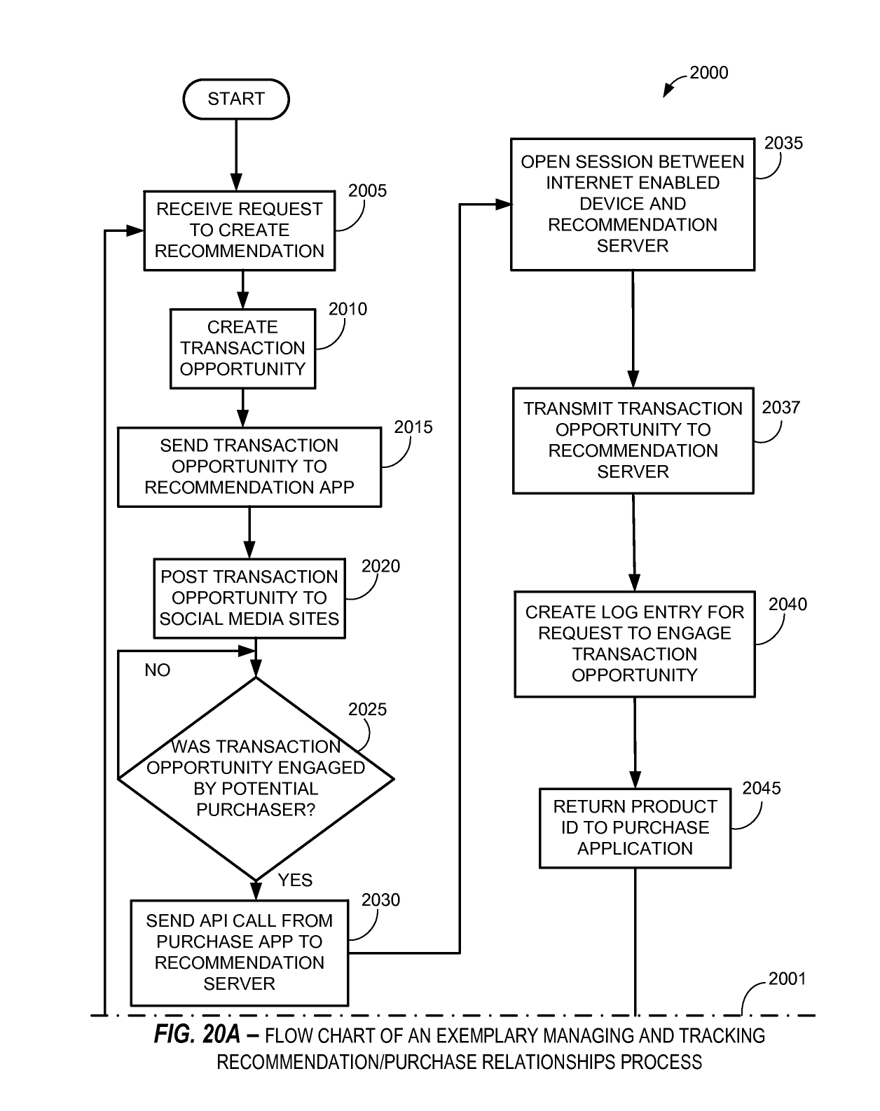

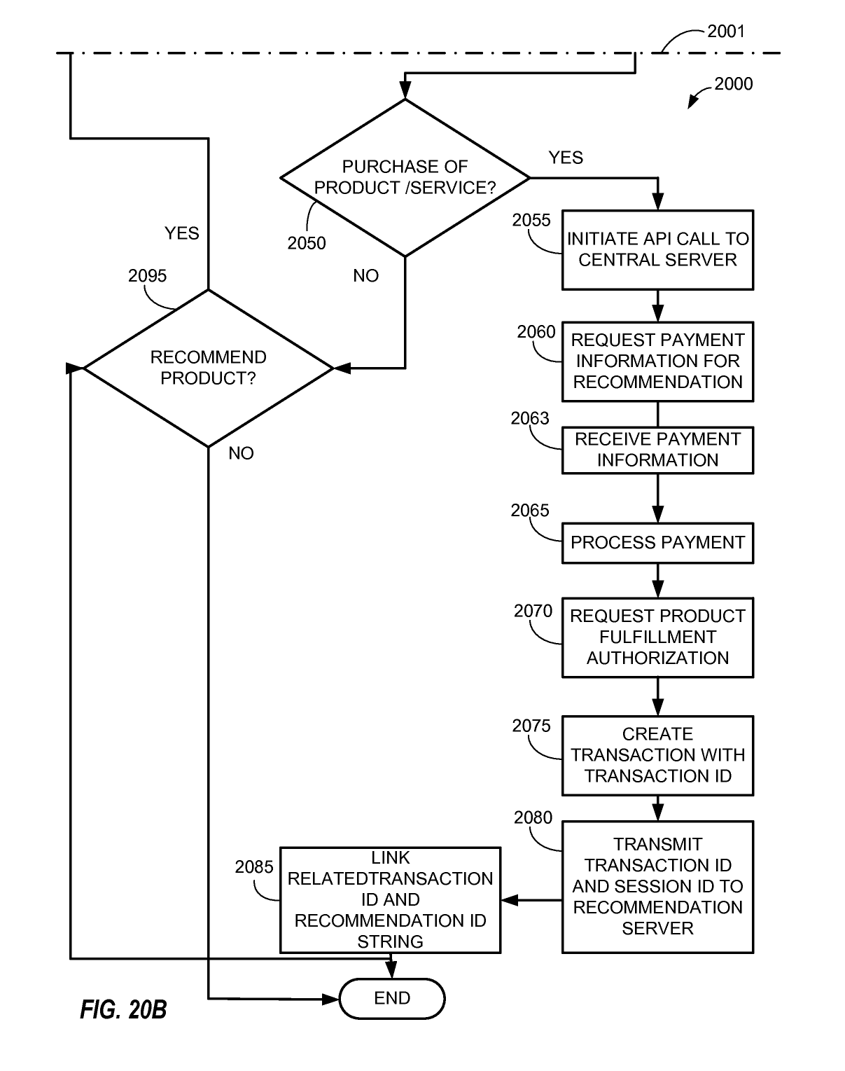

FIGS. 20A and 20B are flow charts illustrating an exemplary recommendation transaction process 2000, according to one embodiment of the present disclosure. Referring to FIG. 20A, when the internet enabled device 20 makes a request to make a recommendation, the recommendation application 106 will make a data request through an application programming interface API to the recommendation server 30, as illustrated in step 2005. In addition to the request, the recommendation application 106 can send information that identifies the recommender, product/offer, retailer, and any previous recommender/recommendation. In an aspect, the recommendation ID/recommender ID of previous recommendations can be sent from recommendations received by the user of the internet enabled device 20. The recommendation application 206 of the recommendation server 30 will then create a recommendation entry 80, which was discussed earlier in connection with FIG. 5 and will be discussed in greater detail in connection with step 2085 of FIG. 20B.

At step 2010, the recommendation server 30 will then generate a transaction opportunity 90, as shown in FIG. 6. In one aspect, the transaction opportunity 90 comprises a transaction opportunity ID 92, the recommendation ID 80, which includes the product ID 84, as well as additional product information 94. In an aspect, the transaction opportunity 90 is represented as an encrypted data string.

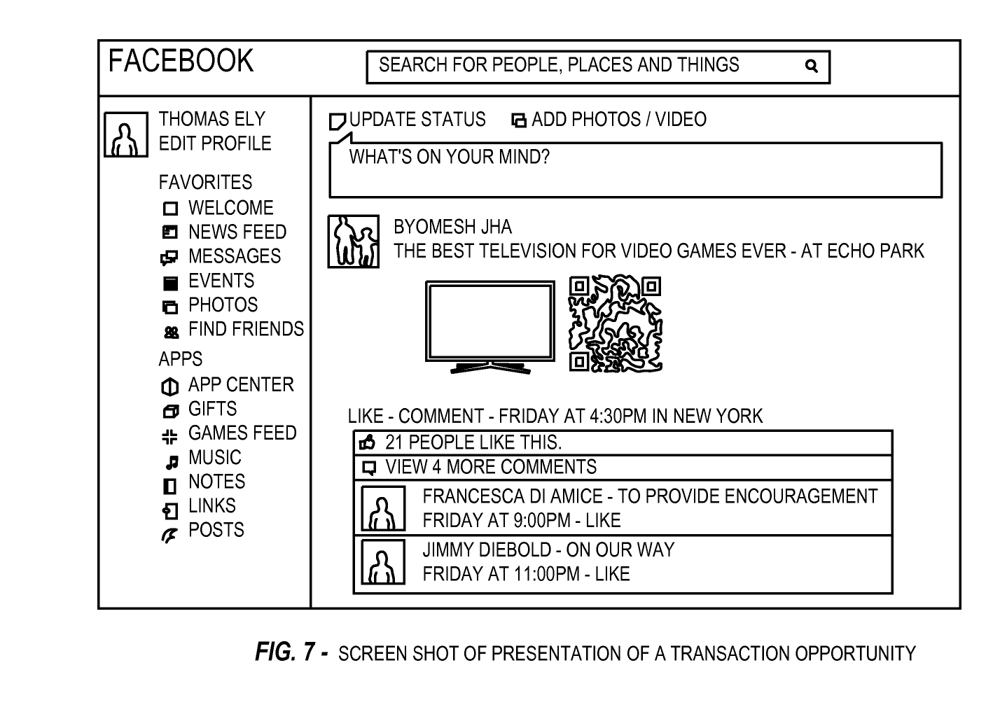

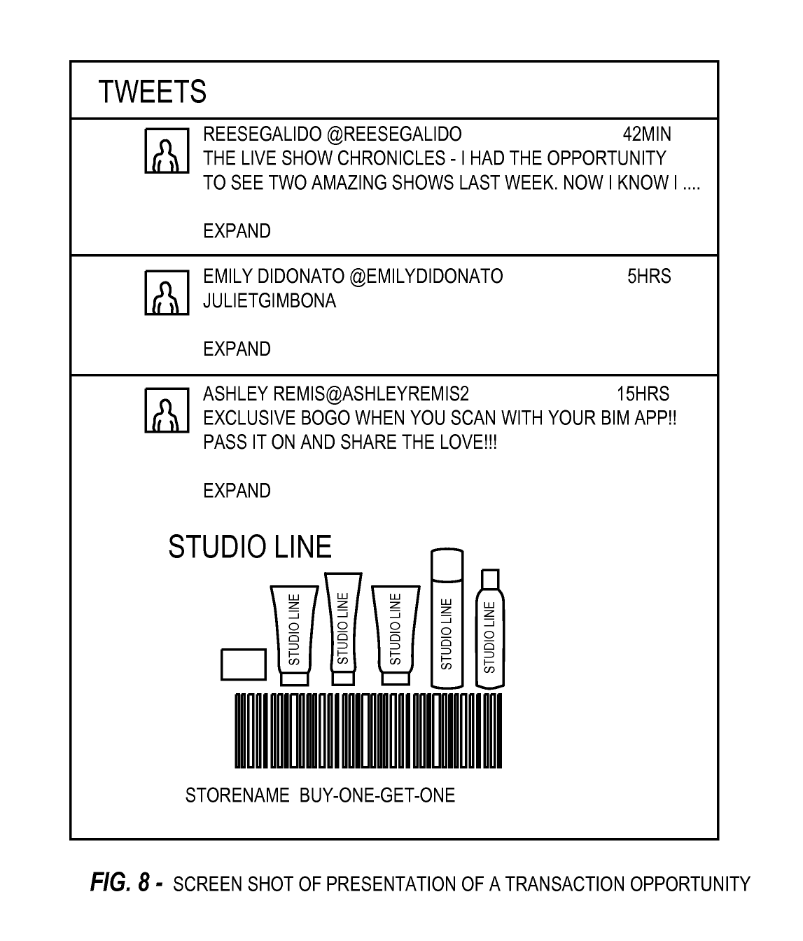

Once the transaction opportunity 90 is generated, the recommendation server 30 will then send the transaction opportunity 90 back to the internet enabled device 20 of the recommender, as shown in step 2015. In an aspect, the transaction opportunity 90 can be returned to the internet enabled device 20 in an encrypted and signed data string. The transaction opportunity 90 can then be generated in a visualized form of a QR code (FIGS. 7, 9-10) or a bar code (FIG. 8). In an aspect, the transaction opportunity 90 comprising the (optionally encrypted and signed) data string can be embedded within a QR code, bar code, internet link, digital image, photograph, or other similar representation as will occur to one of skill in the art. In one aspect, a transaction opportunity may publish as one visual form or may publish in many different visual forms. For example, a user may opt to publish each visual representation or only one visual representation. In an aspect, a separate campaign management server (not shown) can assemble a recommendation creative (e.g., FIG. 7) that includes the dynamically generated transaction opportunity 90 (e.g., a QR code). In other aspects, the transaction opportunity 90 can be returned in other forms that promote data sharing, including but not limited to, near-field-communication (NFC), infra-red and blue-tooth. The transaction opportunity 90 can be sent back via the API.

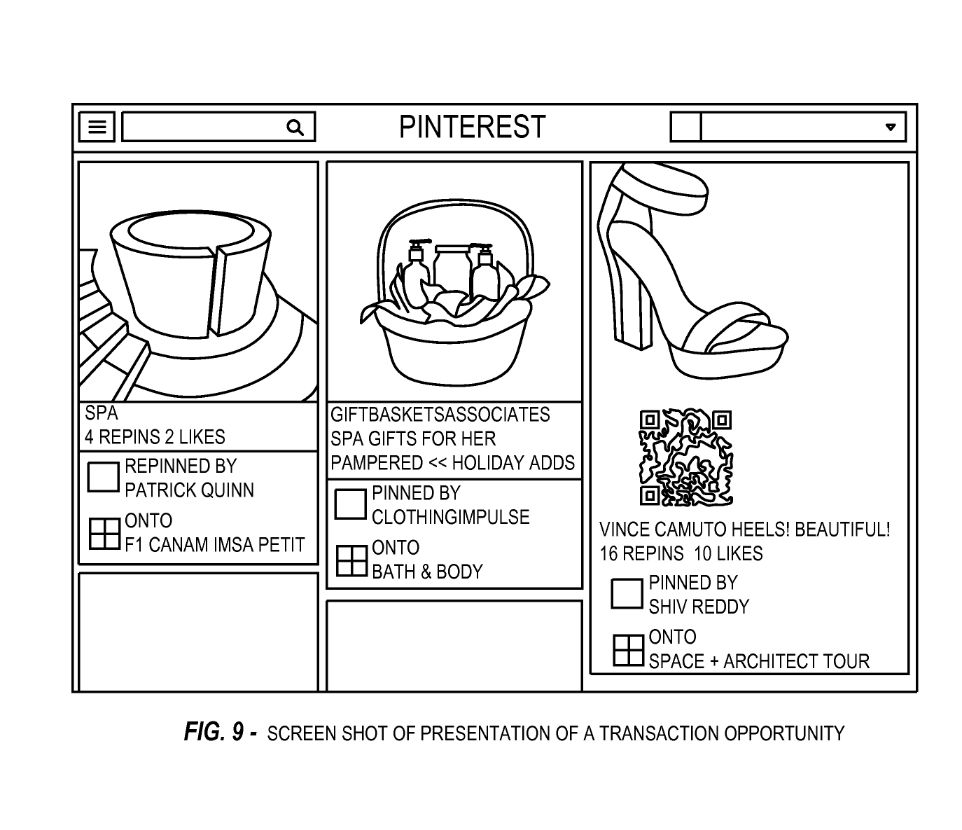

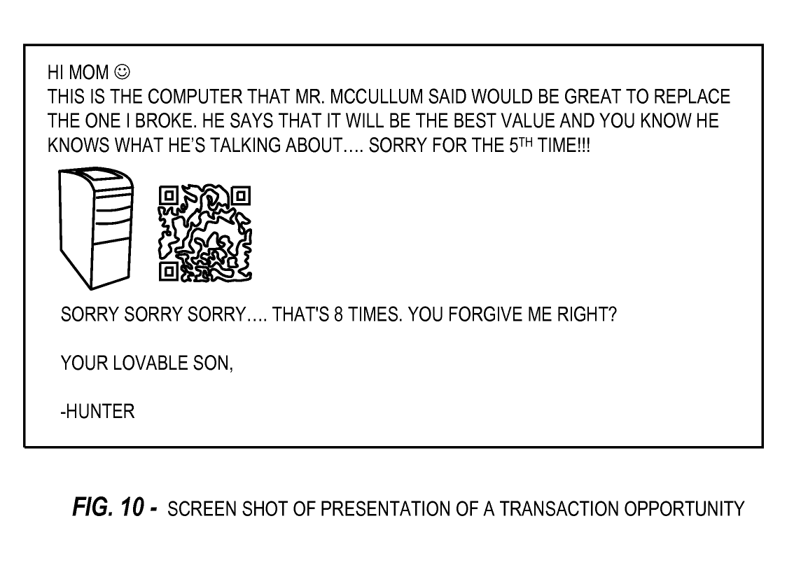

Once the recommender receives the transaction opportunity 90 (step 2015), the internet enabled device 20, via the recommendation application 106, can then send (e.g., post) the transaction opportunity 90 to individuals to which the recommender is connected to via various social networks, as shown in step 2020. For example, the transaction opportunity 90 can be shared on Facebook (FIG. 7), Twitter (FIG. 8), Pinterest (FIG. 9), or through email (FIG. 10) via conventional online affinity mechanisms.

In an aspect, the transaction opportunity 90 can be presented as a QR, barcode, or any other similar display means, as discussed above. Further, additional information can be provided about the transaction opportunity 90, including information and/or images of the product or service being recommended. In an aspect, the purchaser application 107 is linked in advance to the user IDs and passwords of respective user social network accounts. In one aspect, there is one login and password for shopping all the way through the payment process. In another aspect, there may be separate login and passwords for different parts of the process. This is a typical “share” button on most mobile applications enabled by a single-sign-on authorization schema. Email is done by the recommendation application 106 (if this feature is enabled) and links to the existing email on the application (see Pinterest, Flipboard, Pulse, etc.).

A potential purchaser then can be presented with the transaction opportunity 90 (e.g., via display on an internet enabled device). If potential purchaser is interested in engaging the transaction opportunity 90, the potential purchaser can then call on the purchasing application 107. In one aspect, the potential purchaser may engage the transaction opportunity 90 to view additional details about the product, the recommendation, etc. In another aspect, the potential purchaser may engage the transaction opportunity by clicking on the transaction opportunity. In another aspect, the potential purchaser may engage the transaction opportunity by using an electronic device to engage a QR code, bar code, etc., that may, in one embodiment, be embedded on another electronic device. In yet another aspect, the potential purchaser may engage the transaction opportunity to purchase the product or service advertised by the recommendation.

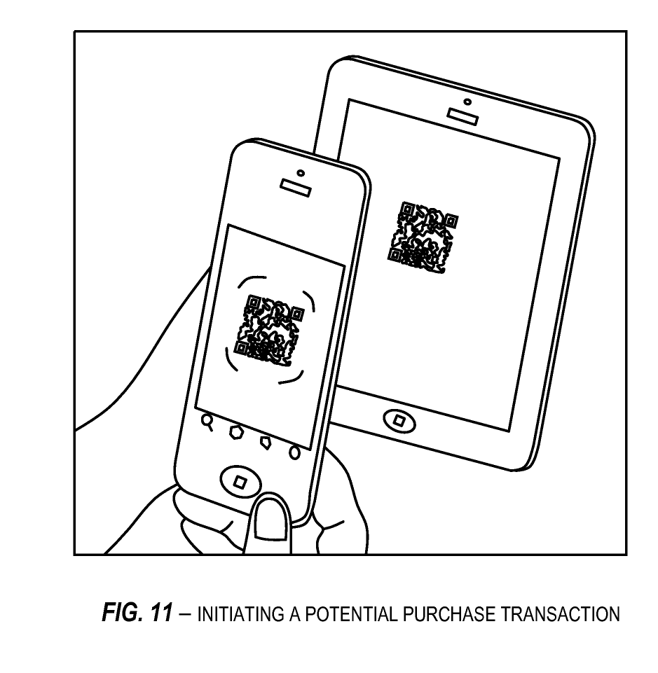

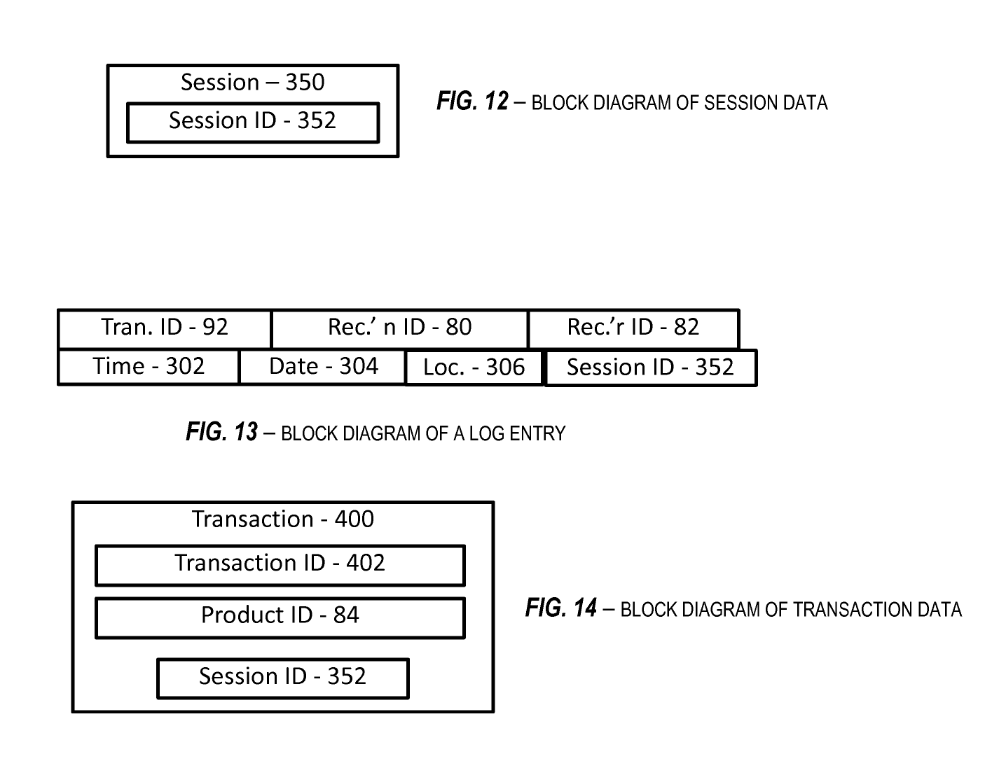

In one embodiment, the potential purchaser can initiate the purchasing application by scanning the transaction opportunity 90 (as shown in FIG. 11), or by manually entering in a corresponding data string (e.g., when the phone on the internet enabled device 20 is not functioning, but the user has the data string available), or by clicking an internet link, an interactive image, etc., as shown in step 2025. Once the transaction opportunity 90 has been selected, the purchasing application 107 can send an API call to the recommendation server 30 with the encrypted and signed data string (the transaction opportunity), as illustrated in step 2030. A session 350 can be opened between the internet enabled device 20 of the engager and the recommendation server 30, as shown in step 2035. The session 350 can include a session ID 352, which can be logged as shown in FIG. 12. The session 350 can begin, or current session recorded, when a user begins a purchase from a stored or scanned QR code. At step 2037 and at this point, the transaction opportunity 90 is sent to the recommendation server 30. For security, the session ID 352 is also recorded by the recommendation server 30 and all subsequent applications (to ensure the security of the transaction due to governmental regulation). This session ID 352 is later used to associate the transaction ID 92 to the recommendation ID 81 in step 9, discussed below.

In an aspect, at step 2040, the recommendation server 30 can then call upon a logging application 203 to generate a log entry 300 for the request, as shown in FIG. 13. The log entry 300 can include information regarding the transaction opportunity 90. In an aspect, the log entry 300 can include the transaction opportunity ID 92, the recommendation ID 81, the recommender ID 82, as well as the time 302, date 304 of the request, etc. In addition, other information that can be transmitted from the internet enabled device 20 (e.g., location information 306) can be included as well, including the session ID 352. At step 2045, the recommendation server 30 can then return the product ID 84 back to the purchase application 107 on the internet enabled device 20 of the potential purchaser. The product ID 84 is sent without breaking the session via the API call.

Referring now to FIG. 20B, which is a continuation of FIG. 20A, via line 2001, once the product ID 84 has been received, the potential purchaser can decide either to make a purchase of the product/service as shown in step 2050, or recommend the product/purchase, shown in step 2095, wherein if the potential purchaser decides to recommend the product, the process returns to step 2005. Alternatively, if the potential purchaser decides not to purchase the item, nor make a recommendation, the exemplary process ends. If the potential purchaser decides to purchase the product (i.e., the product ID 84), the purchasing application 107 initiates an API call to call the central server 70, shown at step 2055.

In an aspect, the purchasing application 107 can be initiated when a corresponding buy button/GUI is selected, initiating the purchase workflow. The purchasing application 107 can request the availability of the product, product descriptions, and additional information. In an aspect and at step 2060, the request can also include payment details, shipping addressees, billing addressees, and the like. If payment is not facilitated directly between the central server 70 and the purchasing application 107, but requires a third party facilitator (e.g., PayPal™ as used on eBay™), the purchase application 107 can call on the payment processing application 108 to request such payment information from a payment provider server 50, shown in step 2060. In an aspect, the purchase application server 40 can also be called if a transaction opportunity 90 is stored for later use.

At step 2065, once the payment authorization is granted, the payment authorization is put into a pending status, which can be triggered by purchase confirmation, by the payment processing application. This can be done by multiple forms of generally accepted interapplication programming languages and methods.

Next, the central server 70 calls upon the merchant retail application 208 of the merchant server 60 to request a product fulfillment authorization, shown at step 2070. If the merchant retail application 208 grants the product fulfillment authorization, the authorization is then put into a pending status triggered by the confirmation of the purchase. This can be done by multiple forms of generally accepted inter-application programming languages and methods, including, but not limited to APIs, custom integrations, and XML feeds.

At step 2075, once the purchaser confirms the purchase, a transaction 400 is created (FIG. 14), with the central server 70 generating a transaction ID 402. The transaction 400 can include product ID 84 and session ID 352. The transaction ID 402 is then communicated to all applications involved for audit and tracking purposes. In an aspect, the central server 70 can create the transaction ID 402 and is required to send it to the purchase application 207, the merchant application 209, and the payment processing application 208. Once the transaction ID 402 is generated, the product fulfillment authorization is taken out of pending status and initiates the merchant retail application to begin fulfillment. In addition, the payment authorization is taken out of pending status, and the payment processing application is initiated to begin the transfer of funds. In an aspect, the central server 70 sending the transaction ID 402 to the relevant servers triggers taking fulfillment and payment out of pending. Once payment is confirmed, the merchant sends the product for fulfillment. As will be understood and appreciated, the above processes can occur virtually instantaneously (e.g., within a few milliseconds).

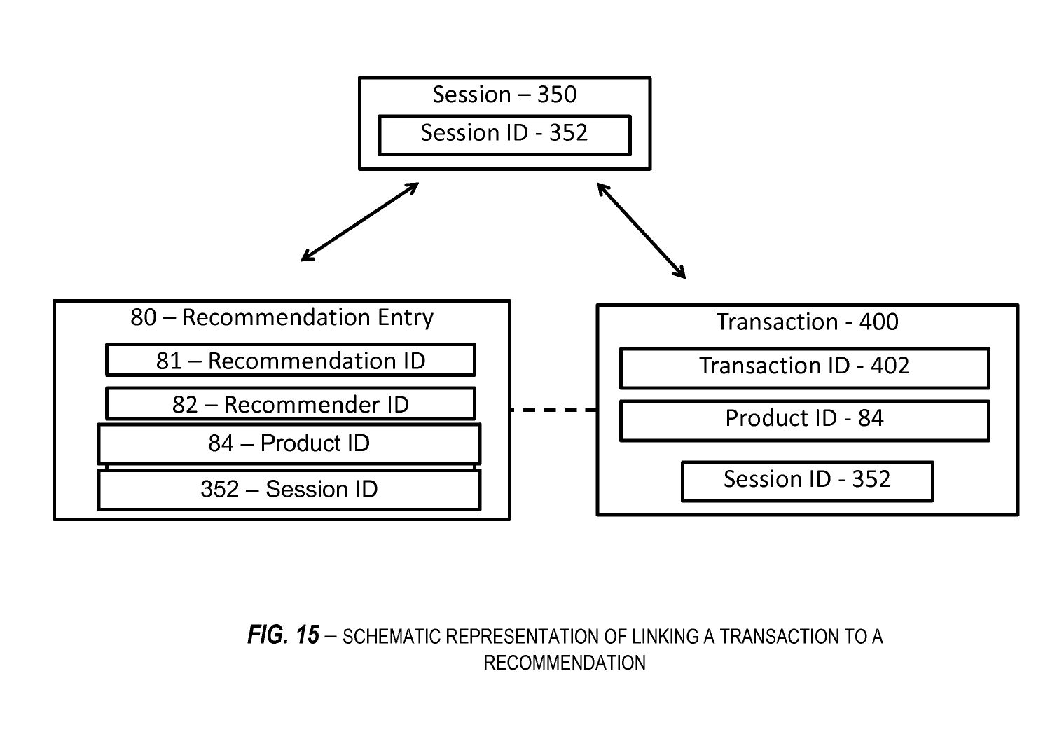

At step 2080, the central server 70 then sends the transaction ID 402 and session ID 352 to the recommendation server via an AP call. The transaction ID 402 and session ID 352 can be sent in an encrypted and signed form. Upon receiving the transaction ID 402 and the session ID 352, the recommendation server 30 can then link the transaction ID 402 to the recommendation ID 80 through the session ID 352, as shown in FIG. 15 and step 2085. In one embodiment and shown in FIG. 15, the recommendation entry 80 comprises a session ID 352 data block and the transaction 400 contains a session ID 352 data block. Accordingly, the system matches recommendations and recommenders to a transaction by correlating the session ID within the transaction 400 to the corresponding session ID 352 within a recommendation entry 80. In an aspect, correlation and related derivation of data is done by a correlation engine 211. The correlation engine 211 is responsible for processing multiple levels of correlation data between recommenders, recommendations, products, and purchases. The correlation engine 211 also dynamically generates graphs encapsulating relationships between every party involved In a recommendation or a sale.

In one aspect, the correlation engine 211 can correlate the lineage of a recommendation from generation to generation. As referred to herein, a generation is typically a level or degree within the lineage of a recommendation. For example, a first recommendation made may be “generation zero”, wherein a second recommendation that is associated or linked to the first recommendation may be referred to as “generation one”. Further, generations may span from “generation zero” to the nth generation, wherein the number of generations is the number of times a recommendation is re-recommended. In an aspect, recommendations are tracked via the recommendation ID 81, the corresponding recommender ID 82, and the previous recommender ID 88 through the correlation engine 211. In another aspect, the correlation engine 211 may correlate a purchase to a recommendation and a subsequent recommendation made from said purchase, which is linked to a first recommendation. Further, in certain aspects, the correlation engine can correlate the number of recommendations for a product, the number of purchases associated with a recommendation, the number of purchases associated with a user, the number of entry visits associated with a single user across generations of recommendations.

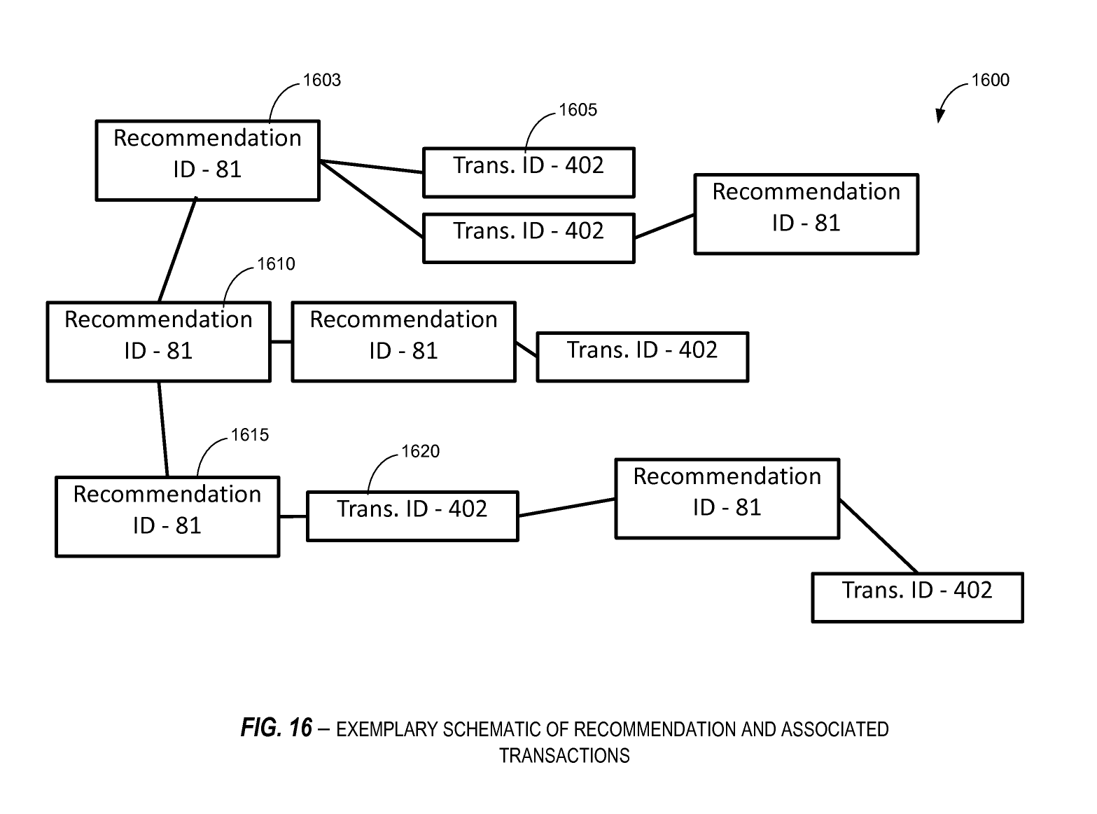

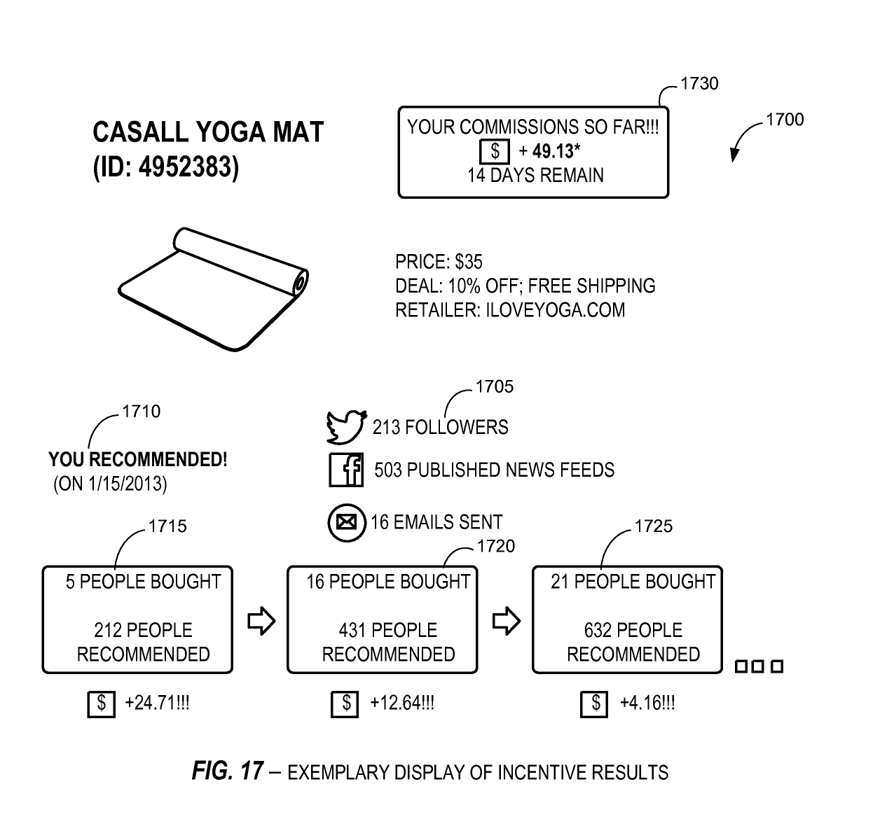

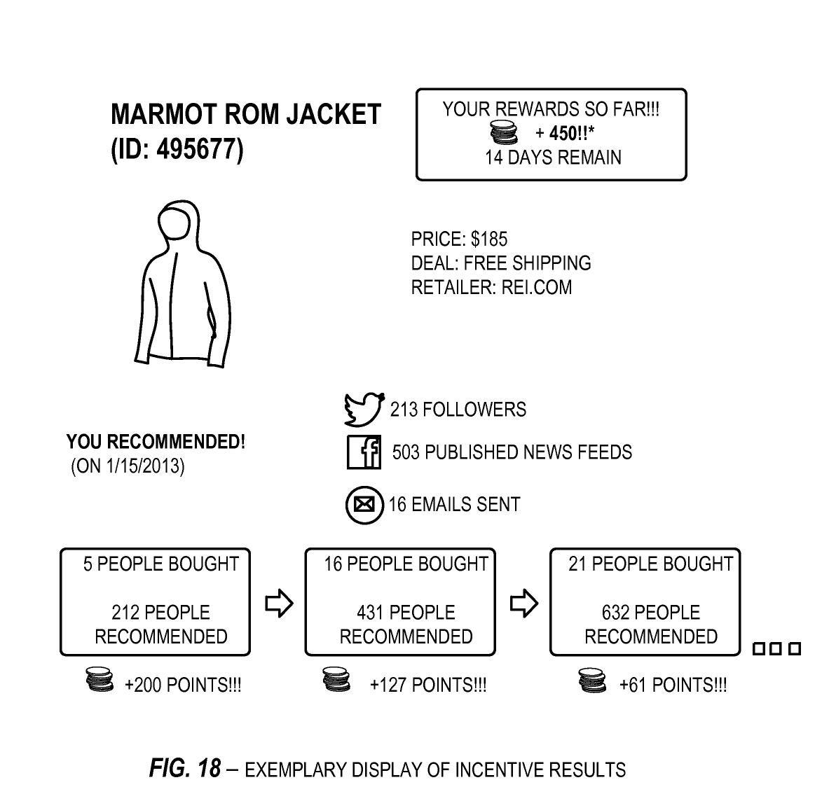

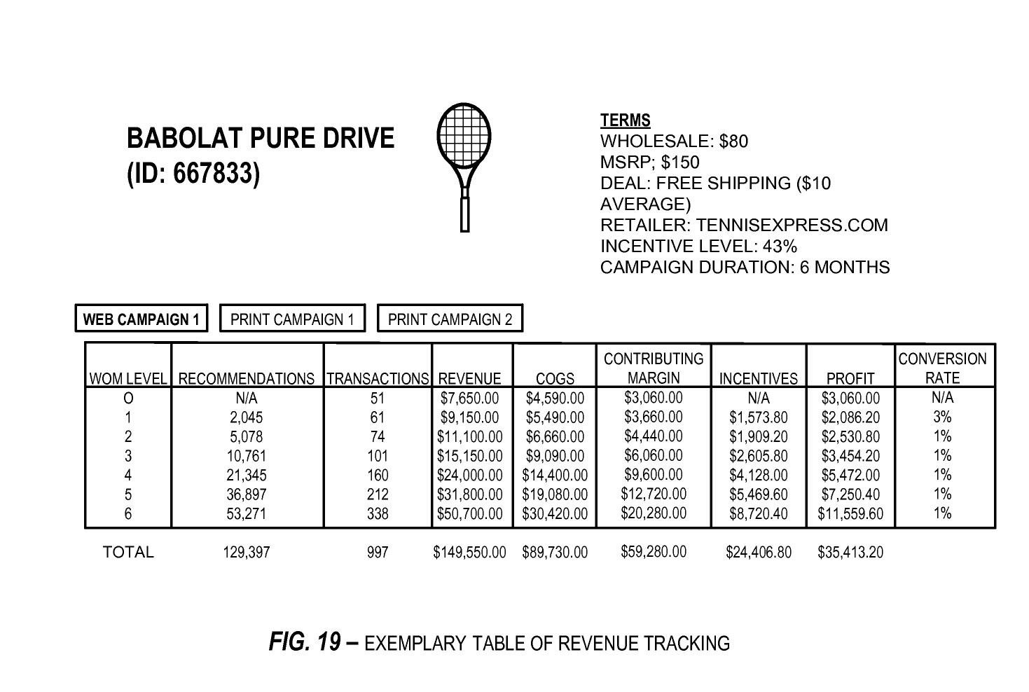

A relationship is now created between the discrete recommenders (recommender ID 82), recommendations (recommendation ID 80), and purchases (transaction ID 402). In addition, this relationship makes it possible to link recommendations and purchases from initial recommendations, as shown in FIG. 16. Such relationships can be used to provide incentives for recommenders (FIGS. 17-18), as well as show how such recommendations result in concrete sales (FIG. 19). In one aspect, the correlation engine 211 tracks recommendations through the generations to identify recommenders who are entitled to various incentives. According to one aspect, the correlation engine associates and tracks recommendations through generations by identifying if a recommendation has a previous recommender ID 88, querying for the previous recommender ID 88, and repeating the process until the previous recommender ID 88 field is blank. It will be understood that the correlation engine 211 will then know the entire lineage of a recommendation and which recommenders are entitled to the various incentives. In one embodiment, incentive rewards are typically decreased for the original recommender as the recommendation proceeds along a generation path.

FIG. 16 illustrates a schematic of an exemplary linkage 1600 of recommendations and transactions associated to various recommendations, according to one embodiment of the present disclosure. As previously described, the recommendation tracking system via the correlation engine 211 tracks recommendations and transactions associated with various recommendations. In one aspect, recommendation ID 1603 is illustrated as a “generation zero” recommendation, wherein it is the first and originating recommendation for a particular product or service. According to one aspect, transaction ID 1605 represents a transaction that occurred as a result of and is linked to the “generation zero” recommendation ID 1603. As previously described, the recommendation tracking system is configured such that recommendations may be created from an earlier generation recommendation. As shown in FIG. 16 and in one aspect, recommendation ID 1610 corresponds to a “generation one” recommendation and recommendation ID 1615 corresponds to a “generation two” recommendation. Thus, for example, a user that viewed recommendation zero 1603 liked the recommendation, and further recommended it to his/her online network. According to one aspect, through tracking recommendation IDs, recommender IDs, the “generation two” recommendation ID and associated recommendation can be traced back to the “generation zero” recommendation ID 1603 and associated recommendation via the “generation one” recommendation ID 1610.

In one aspect, the second transaction ID 1620 that corresponds to a second transaction made in the exemplary schematic illustrated in FIG. 16 can be traced back to the “generation zero” recommendation ID 1603 via the “generation two” recommendation ID 1615 and subsequently the “generation one” recommendation ID 1610. As previously described, the correlation engine 211 correlates recommendation IDs with transaction IDs via the session ID 352 to ensure appropriate tracking of the recommendations and associated purchases.

FIGS. 7-10 illustrate exemplary screen shots of presentations of various visual representations of transaction opportunities, according to one embodiment of the present disclosure. As shown in FIG. 7 and in one embodiment, a visual representation comprising a QR code 705 may be posted to an online networking site. As previously discussed, the visual representation comprises campaign information about a product/service. FIG. 8 illustrates a bar code 805 as a visual representation of a transaction opportunity posted to an online social network. In another embodiment, FIG. 9 illustrates a QR code 905 posted to an online social network comprising campaign information about a product. In yet another embodiment, FIG. 10 illustrates an email with a QR code 1005 embedded in the message comprising campaign information about a product. As will be generally understood, the above examples are exemplary visual representations of a transaction opportunity and are not intended to limit the scope or the spirit of the present disclosure.

FIGS. 17 and 18 illustrate exemplary displays of incentive results 1700, 1701, according to one embodiment of the present disclosure. As shown in FIG. 17, an exemplary yoga mat (i.e., a product that was recommended) is shown with its associated recommendation information. In one aspect, the recommendation tracking system can show how many times a recommendation has been recommended (e.g., tweeted, posted, and/or the number of emails sent with a URL comprising embedded recommendation information 1705). Further, in one aspect, the recommendation tracking system can display a recommendation status (e.g., you recommended this item) 1710 indicating various information about the recommendation created about the particular item. In another aspect, the incentive results display 1700, 1701 can show generation data associated with purchases and transactions according to various recommendation engagement at particular generations. According to one aspect, at a “generation zero” recommendation level 1715, 212 other users recommended the same yoga mat at a “generation zero” recommendation level 1715. Further, it is illustrated that the users who have opted-in to the system and created or shared recommendations have earned $24.71 from “generation zero” recommendation transactions, according to one aspect of the present disclosure.

In one aspect, the exemplary incentives display 1700 comprises a “generation one” recommendation level 1720 displaying the number of recommendations (including “generation-zero” recommendations) that have been made for the exemplary yoga mat. Further, the “generation one” recommendation level also illustrates 16 people have purchased the yoga mat from recommendations originated from the recommendation tracking system and $12.64 have been earned in incentives. Likewise, “generation two” recommendation level 1725 illustrates 632 people have created recommendations (“generation zero” and “generation one” recommendations included) and the $4.16 have been earned in incentives. Further, the exemplary display of incentive results 1700, displays the particular user has earned $49.13 in incentives 1730.

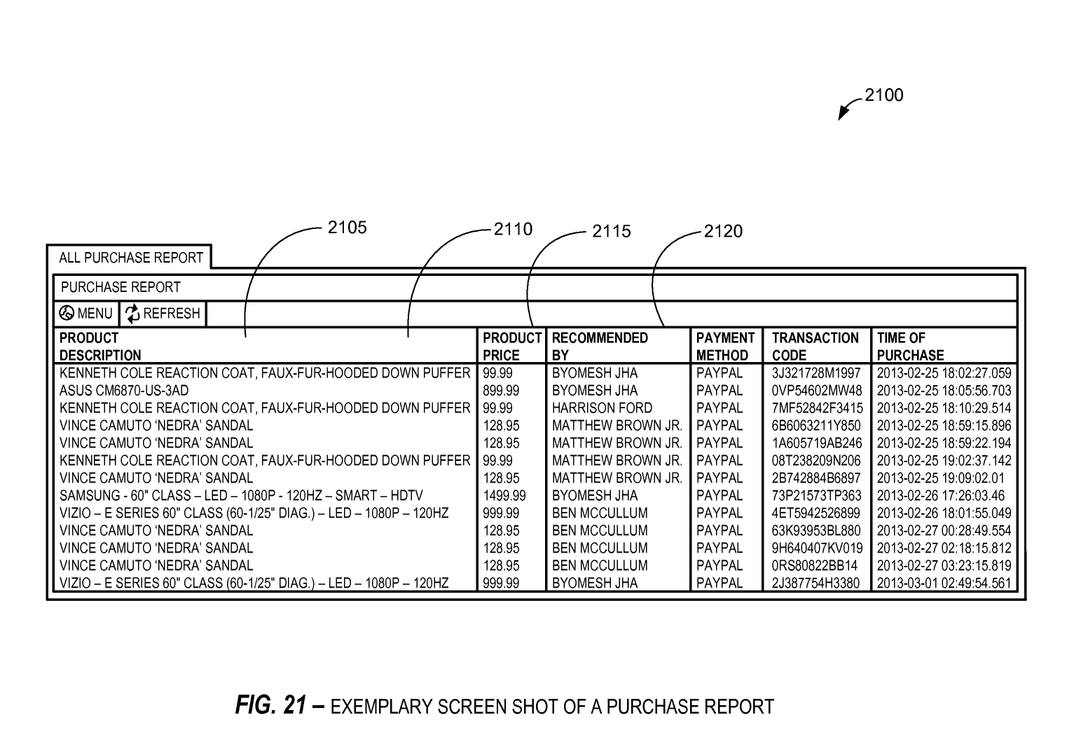

FIG. 21 illustrates an exemplary screen shot of a purchase report, according to one embodiment of the present disclosure. In one aspect, the purchase report 2100 comprises various fields that represent various data aspects relating to managing and tracking recommendations and purchases within the present system from a system administrator or enterprise user perspective. In one aspect, the purchase report 2100 may be accessed and/or viewed by an entity (e.g., company, enterprise, corporation, etc.) for further analyzation of sales, recommendation tracking, payment methods, etc. According to one aspect, the product description column 2105 comprises a description of the product or service that was purchased (and recommended). In another aspect, the product price column 2110 comprises the price of the various product or service that was purchased, the recommendation column 2115 tracks who made the recommendation, and the payment method column 2120 displays the payment method of the recommendation. In one aspect, the recommended by column 2115 may display the “generation zero” recommender. In another aspect, the recommended column may display the recommendation predecessor immediately prior to the purchase of the product or service. According to one aspect, the present system is able to track who made the recommendation, the cost of the purchase, the good or service purchased, and the method of payment. In one aspect, the system can determine various data aspects such as who recommends products/services the most, what the most efficient method of marketing may be, the quantity of incentives if it is determined by price of the good or service, etc.

What has been briefly described, and according to one embodiment, aspects of the present disclosure generally relate to systems and methods for tracking and identifying recommending events that lead to a fully consummate online transaction. In an aspect, the recommendation tracing system can be configured to track and store all data from a chain of recommendations that lead to a discrete transaction. In an aspect, the transactions and recommendations can be carried out through an internet enabled device. In an aspect, the tracking system can be utilized to reward individuals that share a recommendation that ultimately leads to a discrete transaction.

To the extent necessary to understand or complete the disclosure of the present disclosure, all publications, patents, and patent applications mentioned herein are expressly incorporated by reference therein to the same extent as though each were individually so incorporated.

Having thus described exemplary embodiments of the present disclosure, those skilled in the art will appreciate that the within disclosures are exemplary only and that various other alternatives, adaptations, and modifications may be made within the scope of the present disclosure. Accordingly, the present disclosure is not limited to the specific embodiments as illustrated herein, but is only limited by the following claims.

Accordingly, it will be understood that various embodiments of the present system described herein are generally implemented as a special purpose or general-purpose computer including various computer hardware as discussed in greater detail below. Embodiments within the scope of the present disclosure also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, the disclosures are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the disclosure may be practiced in network computing environments with many types of computer system configurations, including personal computers, hand-held devices, multi-processor systems, microprocessor-based or programmable consumer electronics, networked PCs, minicomputers, mainframe computers, and the like. The disclosure is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the disclosures, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the disclosures will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the disclosures are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the disclosure is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote memory storage device. It will be appreciated that the network connections described or shown are exemplary and other mechanisms of establishing communications over wide area networks or the Internet may be used.

In view of the foregoing detailed description of preferred embodiments of the present disclosure, it readily will be understood by those persons skilled in the art that the present disclosure is susceptible to broad utility and application. While various aspects have been described in the context of a preferred embodiment, additional aspects, features, and methodologies of the present disclosure will be readily discernible from the description herein, by those of ordinary skill in the art. Many embodiments and adaptations of the present disclosure other than those herein described, as well as many variations, modifications, and equivalent arrangements and methodologies, will be apparent from or reasonably suggested by the present disclosure and the foregoing description thereof, without departing from the substance or scope of the present disclosure. Furthermore, any sequence(s) and/or temporal order of steps of various processes described and claimed herein are those considered to be the best mode contemplated for carrying out the present disclosure. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present disclosures. In addition, some steps may be carried out simultaneously.

The embodiments were chosen and described in order to explain the principles of the disclosures and their practical application so as to enable others skilled in the art to utilize the disclosures and various embodiments and with various modifications as are suited to the particular use contemplated. Alternative embodiments will become apparent to those skilled in the art to which the present disclosures pertain without departing from their spirit and scope. Accordingly, the scope of the present disclosures is defined by the appended claims rather than the foregoing description and the exemplary embodiments described therein.

What is claimed is:

1. A method for managing and tracking product/service recommendations, comprising the steps of:
receiving an indication at a central server from a user via a user device application relating to a recommendation of a product/service, wherein the recommendation corresponds to an online network;
generating a transaction opportunity identifier at the central server associated with the recommendation, wherein the transaction opportunity identifier includes an user identifier corresponding to the user device application and a recommendation identifier corresponding to the recommendation;
transmitting the transaction opportunity identifier from the central server to the user device application; and
publishing the transaction opportunity identifier to the online network in connection with the recommendation of the user,
whereby the published transaction identifier enables tracking of engagement by other online network users with the recommendation of the product/service by the user.

2. The method of claim 1, further comprising the steps of:
receiving an indication at the central server from a further user indicating engagement with the transaction opportunity identifier in connection with the recommendation of the product/service by the user;
creating a log entry within the central server of the indication from the further user indicating engagement with the recommendation of the product/service by the user; and
storing the log entry reflecting the further user's engagement with the recommendation of the product/service by the user.

3. The method of claim 2, wherein the log entry comprises the transaction opportunity identifier, the recommendation identifier, the user identifier, a session identifier, a time identifier, a date identifier, and/or a location identifier.

4. The method of claim 2, wherein the further user's engagement comprises a purchase of the product/service in connection with the recommendation of the product/service.

5. The method of claim 4, further comprising the steps of:
receiving payment information corresponding to a payment process in connection with the further user's engagement of the transaction opportunity identifier;
creating a transaction data element in connection with completion of the payment process of the further user, wherein the transaction data element includes transaction information corresponding to the further user's engagement with the transaction opportunity identifier; and
correlating at the central server the transaction data element to the recommendation identifier corresponding to the product/service of the recommendation.

6. The method of claim 5, wherein the transaction information includes a product/service identifier and a session identifier.

7. The method of claim 5, further comprising the step of receiving an indication at the central server from a further user via a user device application relating to a recommendation of the product/service after completion of the further user's engagement with the transaction opportunity identifier, wherein the recommendation corresponds to the online network.

8. The method of claim 7, wherein a correlation engine correlates the transaction data element to the recommendation of the product/server of the user via the session identifier.

9. The method of claim 2, wherein the further user's engagement comprises a re-recommendation of the product/service in connection with the user's recommendation of the product/service as it corresponds to the online network.

10. The method of claim 1, wherein receiving the indication from the user comprises an electronic request from a user electronic device.

11. A system for managing and tracking product/service recommendations, comprising:
at least one server operatively connected to a plurality of devices associated with one or more users desirous of making recommendations of one or more products/services;
at least one database for storing information relating to: (a) the one or more recommendations of products/services made by one or more users, and (b) the one or more transactions made by at the one or more users; and
a processor operatively coupled between the at least one server and the at least one database, wherein the processor is operatively configured to:
receive an indication at the at least one server from a user via a user device application relating to a recommendation of a product/service, wherein the recommendation corresponds to an online network;
generate a transaction opportunity identifier at the at least one server associated with the recommendation, wherein the transaction opportunity identifier includes an user identifier corresponding to the user device application and a recommendation identifier corresponding to the recommendation;
transmit the transaction opportunity identifier from at least one server to the user device application; and
publish the transaction opportunity identifier to the online network in connection with the recommendation of the user,
whereby the published transaction identifier enables tracking of engagement by other online network users with the recommendation of the product/service by the user.

12. The system of claim 11, wherein the processor is further operatively configured to:
receive an indication at the at least one server from a further user indicating engagement with the transaction opportunity identifier in connection with the recommendation of the product/service by the user;
create a log entry within the at least one server of the indication from the further user indicating engagement with the recommendation of the product/service by the user; and
store the log entry in the at least one database reflecting the further user's engagement with the recommendation of the product/service by the user.

13. The system of claim 12, wherein the log entry comprises the transaction opportunity identifier, the recommendation identifier, the user identifier, a session identifier, a time identifier, a date identifier, and/or a location identifier.

14. The system of claim 12, wherein the further user's engagement comprises a purchase of the product/service in connection with the recommendation of the product/service.

15. The system of claim 14, wherein the processor is further operatively coupled to:
receive payment information corresponding to a payment process in connection with the further user's engagement of the transaction opportunity identifier;
create a transaction data element in connection with completion of the payment process of the further user, wherein the transaction data element includes transaction information corresponding to the further user's engagement with the transaction opportunity identifier; and
correlate at the at least one server the transaction data element to the recommendation identifier corresponding to the product/service of the recommendation.

16. The system of claim 15, wherein the transaction information includes a product/service identifier and a session identifier.

17. The system of claim 15, wherein the processor is further operatively configured to receive an indication from a further user via a user device application relating to a recommendation of the product/service after completion of the further user's engagement with the transaction opportunity identifier, wherein the recommendation corresponds to the online network.

18. The system of claim 17, wherein a correlation engine correlates the transaction data element to the recommendation of the product/server of the user via the session identifier.

19. The system of claim 12, wherein the further user's engagement comprises a re-recommendation of the product/service in connection with the user's recommendation of the product/service as it corresponds to the online network.

20. The system of claim 11, wherein receipt of the indication from the user comprises an electronic request from a user electronic device.

21. A method for managing and tracking product/service recommendations, comprising the steps of:
receiving an indication at a central server from a first user via a first user device application relating to a recommendation of a product/service, wherein the recommendation corresponds to an online network;
generating a transaction opportunity identifier at the central server associated with the recommendation, wherein the transaction opportunity identifier includes an first user identifier corresponding to the first user device application and a recommendation identifier corresponding to the recommendation;
transmitting the transaction opportunity identifier from the central server to the first user device application;
publishing the transaction opportunity identifier to the online network in connection with the recommendation of the first user;
receiving an indication at the central server from a second user device application relating to a further recommendation of the product/service from the first user, wherein the further recommendation includes the published transaction opportunity identifier corresponding to the recommendation of the first user;
generating a second transaction opportunity identifier at the central server associated with the further recommendation, wherein the second transaction opportunity identifier includes the transaction opportunity identifier, a further recommendation identifier, a second user identifier corresponding to the second user device application, and the recommendation identifier;
transmitting the second transaction opportunity identifier from the central server to the second user device application; and
publishing the second transaction opportunity identifier to the online network in connection with the further recommendation of the second user,
whereby the second published transaction identifier enables tracking of engagement by other online network users with the recommendation of the product/service by the first user.

22. The method of claim 21, further comprising the steps of:
receiving an indication at the central server from a further user indicating engagement with the second transaction opportunity identifier in connection with the recommendation of the product/service by the first user;
creating a log entry within the central server of the indication from the further user indicating engagement with second transaction opportunity identifier in connection with the recommendation of the product/service by the first user; and
storing the log entry reflecting the further user's engagement with the second transaction opportunity in connection with the recommendation of the product/service by the first user.

23. The method of claim 22, wherein the log entry comprises the second transaction opportunity identifier, the further recommendation identifier, the user identifier, a session identifier, a time identifier, a date identifier, and/or a location identifier.

24. The method of claim 22, wherein the further user's engagement comprises a purchase of the product/service in connection with the recommendation of the product/service by the first user.

25. The method of claim 24, further comprising the steps of:
receiving payment information corresponding to a payment process in connection with the further user's engagement of the second transaction opportunity identifier;
creating a transaction data element in connection with completion of the payment process of the further user, wherein the transaction data element includes transaction information corresponding to the further user's engagement with the second transaction opportunity identifier; and
correlating at the central server the transaction data element to the recommendation identifier corresponding to the product/service of the recommendation by the first user.

26. The method of claim 25, wherein the transaction information includes a product/service identifier and a session identifier.

27. A system for managing and tracking product/service recommendations, comprising:
at least one server operatively connected to a plurality of devices associated with one or more users desirous of making recommendations of one or more products/services;
at least one database for storing information relating to: (a) the one or more recommendations of products/services made by the one or more users, and (b) the one or more transactions made by the one or more users; and
a processor operatively coupled between the at least one server and the at least one database, wherein the processor is operatively configured to:
receive an indication at the at least one server from a first user via a user device application relating to a recommendation of a product/service, wherein the recommendation corresponds to an online network;
generate a transaction opportunity identifier at the at least one server associated with the recommendation, wherein the transaction opportunity identifier includes an first user identifier corresponding to the first user device application and a recommendation identifier corresponding to the recommendation;
transmit the transaction opportunity identifier from the at least one server to the first user device application;
publish the transaction opportunity identifier to the online network in connection with the recommendation of the first user;
receive an indication at the at least one server from a second user device application relating to a further recommendation of the product/service from the first user, wherein the further indication includes the published transaction opportunity identifier corresponding to the recommendation of the first user;
generate a second transaction opportunity identifier at the at least one server associated with the further recommendation, wherein the second transaction opportunity identifier includes the transaction opportunity identifier, a further recommendation identifier, a second user identifier corresponding to the second user device application, and the recommendation identifier;
transmit the second transaction opportunity identifier from the central server to the first user device application; and
publish the second transaction opportunity identifier to the online network in connection with the further recommendation of the second user,
whereby the second published transaction identifier enables tracking of engagement by other online network users with the recommendation of the product/service by the first user.

28. The system of claim 27, wherein the processor is further operatively coupled to:
receive an indication at the at least one server from a further user indicating engagement with the second transaction opportunity identifier in connection with the recommendation of the product/service by the first user;
create a log entry within the at least one server of the indication from the further user indicating engagement with second transaction opportunity identifier in connection with the recommendation of the product/service by the first user; and
store the log entry in the at least one database reflecting the further user's engagement with the second transaction opportunity in connection recommendation of the product/service by the first user.

29. The system of claim 28, wherein the log entry comprises the second transaction opportunity identifier, the further recommendation identifier, the user identifier, a session identifier, a time identifier, a date identifier, and/or a location identifier.

30. The system of claim 28, wherein the further user's engagement comprises a purchase of the product/service in connection with the recommendation of the product/service by the first user.

31. The system of claim 30, wherein the processor is further operatively coupled to:
receive payment information corresponding to a payment process in connection with the further user's engagement of the second transaction opportunity identifier;
create a transaction data element in connection with completion of the payment process of the further user, wherein the transaction data element includes transaction information corresponding to the further user's engagement with the second transaction opportunity identifier; and
correlate at the at least one server the transaction data element to the recommendation identifier corresponding to the product/service of the recommendation by the first user.

32. The system of claim 31, wherein the transaction information includes a product/service identifier and a session identifier.
